(19) United States
(12) Patent Application Publication
(10) Pub. No.: US 2021/0365908 A1
(43) Pub. Date: Nov. 25, 2021

(54) TRACKING USE OF METERED CONTENT FROM A CONTENT DELIVERY SYSTEM

(71) Applicant: T-Mobile USA, Inc., Bellevue, WA (US)

(72) Inventor: Nicholas Pipher, Denver, CO (US)

(21) Appl. No.: 16/882,126

(22) Filed: May 22, 2020

(51) Int. Cl. G06Q 20/12; G06Q 30/06; H04N 21/442; H04N 21/4627

(52) U.S. Cl. CPC G06Q 20/1235; G06Q 20/127; H04N 21/4627; H04N 21/44204; G06Q 30/0631

(57) ABSTRACT

A content provider system device provides a content access device access to metered content and receives data regarding the duration of content access device presentation of that metered content. For example, the metered content may be selected via a user interface to which the content provider system provides access to the content access device and the content provider system may receive the data regarding the duration periodically from the content access device, may request the data from the content access device, and so on. From the data, the content provider system device determines the provided metered content that was actually presented and for how long in order to charge for content that is actually used.

### FIELD

The described embodiments relate generally to tracking use of content. More particularly, the present embodiments relate to tracking use of metered content from a content delivery system.

### BACKGROUND

Content provider systems typically provide a variety of different content to a variety of different content access devices. For example, content provider systems may provide audio content, video content, television programs, movies, broadcast content, on-demand content, streaming content, and so on. Content provider systems may provide such content to televisions, set top boxes, desktop computing devices, laptop computing devices, mobile computing devices, tablet computing devices, smart phones, wearable devices, digital media players, and so on.

Different content providers may provide content to content access devices under a variety of different arrangements. For example, terrestrial broadcast television services may broadcast television programs without charge to content access devices, instead earning revenue via advertisements included in the broadcasts. By way of another example, cable service providers may package access to a variety of different content for a fixed charge, such as a particular charge per month for a particular package regardless of the content that is actually accessed. Such cable service providers may also provide access to on-demand content outside of the respective package for a flat fee charge, such as a rental fee charged before access to an on-demand movie is provided.

### SUMMARY

The present disclosure relates to a content provider system that provides content access devices access to metered content and receives data regarding the duration of content access device presentation of that metered content. For example, the metered content may be selected via a user interface to which the content provider system provides access to the content access device and the content provider system may receive the data regarding the duration periodically from the content access device, may request the data from the content access device, and so on. From the data, the content provider system is able to determine the provided metered content that was actually presented and for how long in order to charge for content that is actually used.

In various embodiments, a content provider system includes a non-transitory storage medium that stores instructions, a communication unit, and a processor. The processor executes the instructions to receive a content selection from a content access device using the communication unit, facilitate access by the content access device to content corresponding to the content selection, receive data regarding a duration of the access using the communication unit, and determine an access charge associated with the access at least using the data.

In some examples, the access charge is associated with a charging time period for the content. In various implementations of such examples, the processor determines the access charge using at least a number of times that the data indicates that the duration of the access exceeds the charging time period. In some implementations of such examples, the processor determines the access charge includes a time period charge when the duration of the access is within the charging time period. In a number of implementations of such examples, the processor determines the access charge includes a time period charge when the duration of the access is more than a minimum threshold and is less than the charging time period or equal to the charging time period.

In various examples, the data regarding the duration of the access corresponds to presentation of the content as the content is being received by the content access device. In a number of examples, the data regarding the duration of the access corresponds to presentation of the content from a stored copy of the content previously received by the content access device.

In some embodiments, a content provider system includes a non-transitory storage medium that stores instructions, a communication unit, and a processor. The processor executes the instructions to provide a content access device access to a content selection interface, facilitate content access by the content access device to content selected via the content selection interface, request data from the content access device regarding a duration of the content access, and determine an access charge using at least the data and the content.

In various examples, the processor determines that the content is metered content before requesting the data. In some examples, the content is a first content, the data is first data, the duration is a first duration, the content access is a first content access, the processor facilitates a second content access by the content access device to a second content selected via the content selection interface, the processor determines that the second content is unmetered content, and the processor omits requesting second data from the content access device regarding a second duration of the second content access. In a number of implementations of such examples, the second content is flat charge content and the processor adds a flat charge for the second content to an aggregate access charge for an account associated with the content access device. In various implementations of such examples, the second content is unassociated with a charge and the processor omits adding the charge to an aggregate access charge for an account associated with the content access device.

In some examples, the processor requests the data after the content is provided to the content access device. In various examples, the processor requests the data periodically.

In a number of embodiments, a content provider system includes a non-transitory storage medium that stores instructions, a communication unit, and a processor. The processor executes the instructions to provide content to a content access device based on a selection from a content selection interface; upon determining that the content is metered content, evaluate data from the content access device regarding a duration of presentation of the content; and determine a metered access charge using at least the data.

In some examples, the processor determines when an aggregate access charge for an account associated with the content access device reaches a notification threshold. In various examples, the processor transmits a notification when an aggregate access charge for an account associated with the content access device reaches a configurable notification threshold. In a number of implementations of such examples, the processor provides a recommendation regarding the content via the content selection interface.

In various examples, the processor determines the metered access charge by including a minimum charge when an aggregate access charge for an account associated with the content access device is below a minimum threshold. In some examples, the processor determines the metered access charge is zero when an aggregate access charge for an account associated with the content access device at least equals a maximum threshold.

### BRIEF DESCRIPTION OF THE DRAWINGS

The disclosure will be readily understood by the following detailed description in conjunction with the accompanying drawings, wherein like reference numerals designate like structural elements.

FIG. 1 depicts an example system for tracking use of metered content from a content delivery system.

FIG. 2 depicts a flow chart illustrating a first example method for tracking use of metered content from a content delivery system. This method may be performed by the system of FIG. 1.

FIG. 3 depicts a flow chart illustrating a second example method for tracking use of metered content from a content delivery system. This method may be performed by the system of FIG. 1.

FIG. 4 depicts a flow chart illustrating a third example method for tracking use of metered content from a content delivery system. This method may be performed by the system of FIG. 1.

FIG. 5 depicts a flow chart illustrating a fourth example method for tracking use of metered content from a content delivery system. This method may be performed by the system of FIG. 1.

FIG. 6 depicts a flow chart illustrating a fifth example method for tracking use of metered content from a content delivery system. This method may be performed by the system of FIG. 1.

FIG. 7 depicts a flow chart illustrating a sixth example method for tracking use of metered content from a content delivery system. This method may be performed by the system of FIG. 1.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The description that follows includes sample systems, methods, apparatuses, and computer program products that embody various elements of the present disclosure. However, it should be understood that the described disclosure may be practiced in a variety of forms in addition to those described herein.

Terrestrial broadcast television services typically do not provide content access devices access to a large variety of content. In most areas, only a handful of local channels may be accessible. In order to access a larger variety of content, subscription to a paid packaged service, such as a cable television service or a streaming service, may be necessary. However, such packages generally include a predetermined set of content that may be accessed for the fixed package charge and users often have to pay for access to content that they do not want in order to obtain access to content that they do want. For example, a user may wish to access content associated with a science fiction channel and may have no use for a country music video channel, but may be required to pay for a package that includes the country music video channel in order to access the content associated with the science fiction channel. Content service provider systems may be capable of determining that the ability to access content is provided to content access devices, but typically content service provider systems cannot determine the durations of content accesses in order to charge users for content that the users actually use as opposed to the traditional access packages. Content provider systems that provide access to content via open networks may be even less able to determine durations of content accesses as opposed to content provider systems that provide access to content via closed networks controlled by the content provider.

The present disclosure relates to a content provider system that provides content access devices access to metered content and receives data regarding the duration of content access device presentation of that metered content. For example, the metered content may be selected via a user interface to which the content provider system provides access to the content access device and the content provider system may receive the data regarding the duration periodically from the content access device, may request the data from the content access device, and so on. From the data, the content provider system is able to determine the provided metered content that was actually presented and for how long in order to charge for content that is actually used.

In this way, the content provider system may be improved by being able to obtain previously unobtainable data, by being able to make determinations that could not be previously made, by being able to provide access to content more efficiently, and so on. Further, the content provider system may be able to perform previously un-performable functions that accommodate pay-as-you-go access plans without charging for a package regardless of the content that is actually used, without charging flat fees for requested content, or without providing content access for free and instead depending entirely on advertising.

In some implementations, the content provider system may control or direct monitoring of content access duration and/or how and when such data is exchanged. For example, the content provider system may provide access to unmetered content (such as content that is included in a package instead of metered content, on-demand content for which a flat fee is charged upon access request, and so on). When unmetered content is requested, the content provider system may instruct that content access duration not be monitored, may omit requesting content access duration, may ignore provided content access duration data, and so on. This may further improve the content provider system by reducing data traffic and improving hardware system performance through minimizing communication between the content provider system and content access devices.

Through the above, the content provider system may be able to perform functions that the content provider system would not previously have been able to perform absent the technology disclosed herein and/or without additional hardware and/or software components. This may enable the system to operate more efficiently while consuming fewer hardware and/or software resources as more resource consuming techniques for determining content access duration may be omitted, reducing unnecessary hardware and/or software components and providing greater content provider system flexibility.

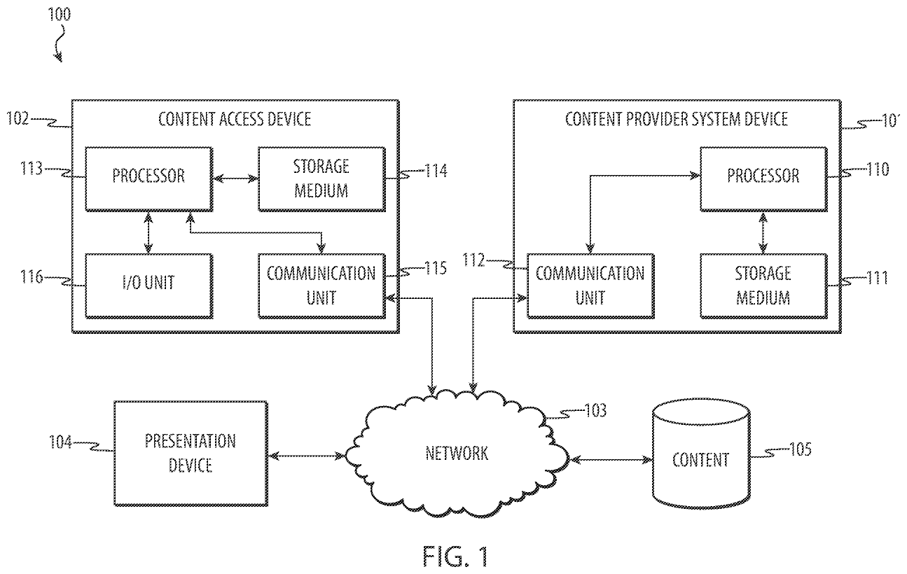

These and other embodiments are discussed below with reference to FIGS. 1-7. However, those skilled in the art will readily appreciate that the detailed description given herein with respect to these Figures is for explanatory purposes only and should not be construed as limiting.

FIG. 1 depicts an example system 100 for tracking use of metered content from a content delivery system. The system 100 may include one or more content provider system devices 101 that are operable to communicate with one or more content access devices 102 via one or more communication networks 103.

The content provider system device 101 may provide the content access device 102 access to metered content. By way of example, the metered content may be stored in a content store 105. The content access device 102 may access and present the metered content. For example, the content access device 102 may receive the metered content as a stream and present that stream as it is received, such as via a television or other presentation device 104 and/or via an integrated component of the content access device 102. In other examples, the content access device 102 may record the metered content and later present the metered content from the recording. In still other examples, the content access device 102 may be prohibited from recording metered content and may instead be required to subscribe to a service package in order to record content.

The content provider system device 101 may receive data regarding the duration of content access device 102 presentation of the metered content. For example, the content provider system device 101 may receive the data regarding the duration periodically from the content access device 102, may request the data from the content access device 102, and so on. From the data, the content provider system device 101 may determine the provided metered content that was actually presented and for how long in order to determine a charge for content that is actually used.

In some implementations, the metered content may be selected via a user interface (such as a content selection interface) to which the content provider system device 101 provides access to the content access device 102. Such a user interface may be configured as an electronic program guide and/or any other kind of user interface. In some examples, the user interface may be generated by the content provider system device 101 and/or provided by the content provider system device 101 to the content access device 102. In other examples, the content access device 102 may generate the user interface using user interface information provided by the content provider system device 101. The user interface may allow a user to search and discover content to request (such as metered content, free content, content included in a subscription package, on-demand content for which there is a flat fee to request, and so on). In some examples, the user interface may include one or more previews of content that may be requested. In various examples, the user interface may be prevented from providing live previews of metered content as payment has not yet been made for the metered content, and/or the preview itself may be metered content for which a metered charge may be assessed.

For example, a customer may pay an initiation fee (such as $5 and/or another amount) to sign up for a metered content account that has no monthly subscription fee. The customer may select metered content and the content access device 102 may present the selected metered content. The content access device 102 may monitor the duration of the metered content access for presentation and report data of such (whether upon request by the content provider system device 101, periodically, upon reaching a charging time threshold or other triggering event, and so on) to the content provider system device 101. For example, the content access device 102 may execute a timer program during the access that records information (such as in a protected memory area inaccessible to the user) regarding the duration of the access (such as the duration of the access, reaching of charging time thresholds, and so on) and/or reports the information to the content provider system device 101. Based at least on the data, the content provider system device 101 may determine an access charge for the access. For example, the access charge may be determined to be zero when the duration is less than a minute, may be determined to correspond to a half hour worth of access once the duration is at least a minute, may be determined to correspond to an additional half hour worth of access once the duration is at least 31 minutes, and so on. Different charges may be associated with access to different metered content, different channels or other content sources associated with different metered content (such as an implementations where metered content associated with premium channels is associated with a higher charge than metered content associated with basic channels), whether the metered content is accessed via a stream or from a recording, and so on.

In some implementations of such an example, the user may be required to pay the initiation fee again if the user has not accessed a certain amount of metered content within a period of time. For example, the user may be required to pay the initiation fee again if the user has not accessed at least $5 worth of metered content within 30 calendar days. In various implementations, charges for all accessed metered content may be capped. For example, a subscriber package including the metered content may cost $75 per month and charges for all accessed metered content within a month may be capped at $75 as effectively determining that the user subscribed to the subscriber package for the month instead of charging more than the cost of the subscriber package since the user accessed the metered content in a metered plan.

In a number of examples, the content provider system device 101 may monitor an aggregate of charges for all accessed metered content and determine when the aggregate reaches various thresholds. Upon reaching a threshold, the content provider system device 101 may transmit one or more notifications to the content access device 102 and/or another associated electronic device (such as a text message or email transmitted to the smart phone or other computing device associated with an account to which the content access device 102 is assigned). For example, the content provider system device 101 may be configured to transmit notifications when the aggregate of charges for all accessed metered content (and/or a bill including such an aggregate along with other charges for package subscriptions, on-demand flat charges, and so on) reaches $10, $15, $20, and so on.

In various implementations, the system 100 and/or the content provider system device 101 may include a content recommendation system. For example, the user interface may provide recommendations corresponding to people associated with the user (such as friends or family), groups of people associated with the user (such as other people in the same city or other region, other people with similar viewing habits), the general public, and so on. The recommendations may be generated automatically based on monitored viewing habits and/or other factors, may be intentionally provided by users with or without ratings or reviews, and so on. For example, this may provide users the ability to recommend content to their friends, family, and/or other people. By way of another example, this could provide users the ability to join “watching groups” where members of a watching group may be able to communicate to share content recommendations, receive notifications when other members post new content recommendations, and so on.

In some implementations, the content provider system device 101 may receive a content selection from the content access device 102. For example, the content provider system device 101 may receive the content selection via a user interface to which the content provider system device 101 provides the content access device 102 access. The content provider system device 101 may facilitate access by the content access device 102 to content corresponding to the content selection. For example, the content provider system device 101 may transmit the content, transmit a manifest specifying one or more locations from which the content access device 102 may pull one or more segments of the content, and so on. The content provider system device 101 may receive data regarding a duration of the access. For example, the content provider system device 101 may request the data, the content access device 102 may periodically transmit the data, the content access device 102 may transmit the data upon reaching a charging time threshold or other triggering event, and so on. The content provider system device 101 may determine an access charge associated with the access at least using the data.

The access charge may be associated with a charging time period for the content, such as a particular charge per half hour access of the content. The content provider system device 101 may determine the access charge using at least a number of times that the data indicates that the duration of the access exceeds the charging time period. For example, the content provider system device 101 may determine the access charge using at least a number of times that the data indicates that the duration of the access exceeds a half hour access. The content provider system device 101 may determine that the access charge includes a time period charge when the duration of the access is within the charging time period. For example, the content provider system device 101 may determine that the access charge includes the time period charge when the duration of the access is more than zero but less than or equal to a half hour. The content provider system device 101 may determine that the access charge includes a time period charge when the duration of the access is more than a minimum threshold and less than the charging time period or equal to the charging time period. For example, the content provider system device 101 may determine that the access charge includes the particular charge when the duration of the access is more than a minimum threshold of 59 seconds and is less than or equal to 30 minutes.

In some situations, the data regarding the duration of the access may correspond to presentation of the content as the content is being received by the content access device 102. In other situations, the data regarding the duration of the access may correspond to presentation of the content from a stored copy previously received by the content access device 102.

In various implementations, the content provider system device 101 may provide the content access device 102 access to a content selection interface. For example, the content selection interface may be an electronic program guide or other user interface that the content provider system device 101 generates and provides to the content access device 102. By way of another example, the content selection interface may be an electronic program guide or other user interface that the content access device 102 generates using information provided by the content provider system device 101. The content provider system device 101 may facilitate content access by the content access device 102 to content selected via the content selection interface. The content provider system device 101 may request data from the content access device 102 regarding a duration of the content access. The content provider system device 101 may determine an access charge using at least the data and the content.

The content provider system device 101 may determine that the content is metered content before requesting the data. The content provider system device 101 may omit requesting the data upon determining that the content is unmetered content as the duration of the content access may be irrelevant to the content provider system device 101 when the content is unmetered.

For example, the content may be a first content that is metered content, the content access may be a first content access, the duration may be a first duration, and the data may be first data. The content provider system device 101 may facilitate a second content access by the content access device to a second content selected via the content selection interface. The content provider system device 101 may determine that the second content is unmetered content and may omit requesting second data from the content access device 102 regarding a second duration of the second content access. The second content may be flat charge content, such as on-demand content that is associated with a flat charge upon request. If so, the content provider system device 101 may add a flat charge for the second content to an aggregate access charge for an account associated with the content access device 102. Alternatively, the second content may be unassociated with a charge, such as free content and/or content associated with a subscription package. If so, the content provider system device 101 may omit adding the charge to an aggregate access charge for an account associated with the content access device 102.

The content provider system device 101 may request the data after the content is provided to the content access device 102. For example, the content may have a length of one hour and the content provider system device 101 may request the data at least an hour after the content is provided.

The content provider system device 101 may request the data periodically. For example, the content provider system device 101 may ping the content access device 102 to request any data regarding metered content access duration every fifteen minutes, half hour, day, month, and so on.

In a number of implementations, the content provider system device 101 may provide content to the content access device 102 based on a selection from a content selection interface. The content provider system device 101 may provide the content by transmitting the content, by providing a manifest including one or more locations from which one or more segments of the content may be requested or pulled, and so on. Upon determining that the content is metered content, the content provider system device 101 may evaluate data regarding a duration of presentation of the content. The content provider system device 101 may receive the data from the content access device 102 directly and/or indirectly. The content provider system device 101 may determine a metered access charge using at least the data.

The content provider system device 101 may determine when an aggregate access charge for an account associated with the content access device 102 reaches a notification threshold. For example, the threshold may be one or more of $10, $20, $50, and so on and may or may not include charges other than charges for metered content presentation.

The content provider system device 101 may transmit a notification when an aggregate access charge for an account associated with the content access device reaches a notification threshold. The content provider system device 101 may transmit the notification to the content access device 102 and/or another electronic device associated with the account. The notification threshold may be configurable. For example, a user may be able to provide input to configure the notification thresholds, how many notification thresholds there are, the amounts associated with the notification thresholds, what charges are analyzed in evaluating one or more of the notification thresholds, and so on.

The content provider system device 101 may determine the metered access charge by including a minimum charge when an aggregate access charge for an account associated with the content access device 102 is below a minimum threshold, such as $5, $10, and so on. The content provider system device 101 may determine that the metered access charge is zero when an aggregate access charge for an account associated with the content access device 102 at least equals a maximum threshold, such as $100 within the time period of a month.

The content provider system device 101 may be any kind of electronic device. Examples of such devices include, but are not limited to, one or more desktop computing devices, laptop computing devices, server computing devices, mobile computing devices, tablet computing devices, set top boxes, digital video recorders, televisions, displays, wearable devices, smart phones, set top boxes, digital media players, and so on. The content provider system device 101 may include one or more processors 110 and/or other processing units and/or controllers, one or more non-transitory storage media 111 (which may take the form of, but is not limited to, a magnetic storage medium; optical storage medium; magneto-optical storage medium; read only memory; random access memory; erasable programmable memory; flash memory; and so on), one or more communication units 112, and/or other components. The processor 110 may execute instructions stored in the non-transitory storage medium to perform various functions. Such functions may include receiving content selections, providing content, facilitating access to content, receiving data, evaluating data, determining access charges, generating user interfaces, providing access to user interfaces, communicating with the content access device 102 over the network 103 via the communication unit 112, and so on.

Similarly, the content access device 102 may be any kind of electronic device. Examples of such devices include, but are not limited to, one or more desktop computing devices, laptop computing devices, server computing devices, mobile computing devices, tablet computing devices, set top boxes, digital video recorders, televisions, displays, wearable devices, smart phones, set top boxes, digital media players, and so on. The content access device 102 may include one or more processors 113 and/or other processing units and/or controllers, one or more non-transitory storage media 114 (which may take the form of, but is not limited to, a magnetic storage medium; optical storage medium; magneto-optical storage medium; read only memory; random access memory; erasable programmable memory; flash memory; and so on), one or more communication units 115, input and/or output units 116, and/or other components. The processor 113 may execute instructions stored in the non-transitory storage medium to perform various functions. Such functions may include receiving content, presenting user interfaces, receiving content requests, forwarding content requests and/or content request selections, presenting content via the input and/or output unit 116 and/or an associated presentation device 104 (such as a display, a speaker, a television, and so on), tracking data, reporting data, transmitting data, receiving requests for data, communicating with the content provider system device 101 over the network 103 via the communication unit 115, and so on.

Although the system 100 is illustrated and described as including particular components arranged in a particular configuration, it is understood that this is an example. In a number of implementations, various configurations of various components may be used without departing from the scope of the present disclosure.

For example, the system 100 is illustrated and described as including a presentation device 104. However, it is understood that this is an example. In various implementations, the system 100 may include a content access device 102 that is configured to present content through the input/output unit 116, such as via one or more integrated displays, speakers, and so on. In such an implementation, the presentation device 104 may be omitted. Various configurations are possible and contemplated without departing from the scope of the present disclosure.

By way of another example, the system 100 is illustrated and described as including a content store 105. However, it is understood that this is an example. In various implementations, the system 100 may include a content provider system device 101 that is configured to provide content stored in the storage medium 111. In such implementations, the content store 105 may be omitted. Various configurations are possible and contemplated without departing from the scope of the present disclosure.

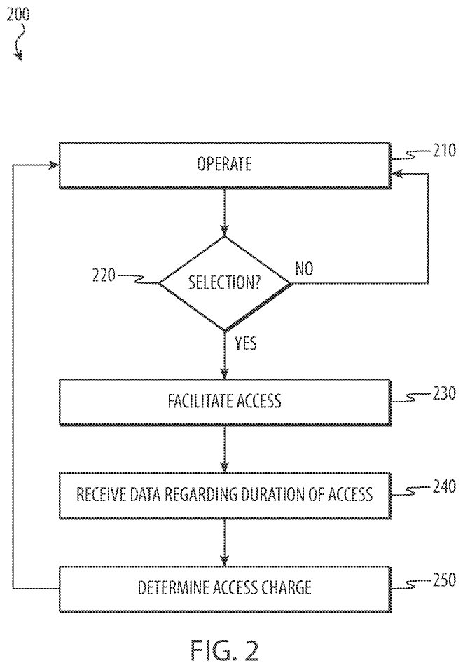

FIG. 2 depicts a flow chart illustrating a first example method 200 for tracking use of metered content from a content delivery system. This method 200 may be performed by the system 100 of FIG. 1.

At operation 210, an electronic device (such as the content provider system device 101 of FIG. 1) operates. The flow may proceed to operation 220 where the electronic device determines whether or not a content selection is received from a content access device. The content selection may be received via a user interface to which the electronic device provides the content access device access. If not, the flow may return to operation 210 where the electronic device may continue to operate. Otherwise, the flow may proceed to operation 230.

At operation 230, the electronic device facilitates access to the selected content. At operation 240, the electronic device receives data regarding the duration of access via the content access device to the selected content. The access may be access for the purposes of presentation of the selected content by the content access device, whether via the content access device and/or an associated presentation device. The electronic device may receive the data periodically from the content access device, may request the data from the content access device, and so on.

At operation 250, the electronic device may determine an access charge for the access. The electronic device may use the data regarding the duration of the access to determine the access charge.

In various examples, this example method 200 may be implemented as a group of interrelated software modules or components that perform various functions discussed herein. These software modules or components may be executed within a cloud network and/or by one or more computing devices, such as the content provider system device 101 of FIG. 1.

Although the example method 200 is illustrated and described as including particular operations performed in a particular order, it is understood that this is an example. In various implementations, various orders of the same, similar, and/or different operations may be performed without departing from the scope of the present disclosure.

For example, operation 230 is illustrated and described as facilitating access to the selected content. However, it is understood that this is an example. In some implementations, the electronic device may transmit the selected content to the content access device. Various configurations are possible and contemplated without departing from the scope of the present disclosure.

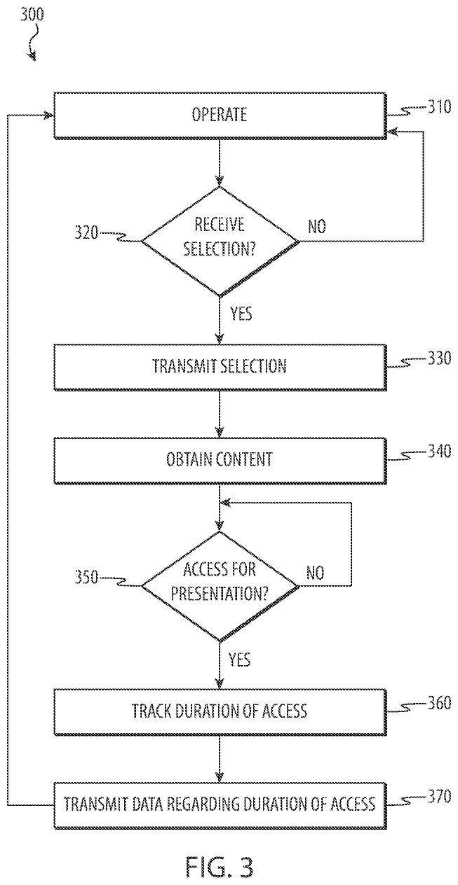

FIG. 3 depicts a flow chart illustrating a second example method 300 for tracking use of metered content from a content delivery system. This method 300 may be performed by the system 100 of FIG. 1.

At operation 310, an electronic device (such as the content access device 102 of FIG. 1) operates. The flow may proceed to operation 320 where the electronic device determines whether or not a content selection is received from a user. The content selection may be received via a user interface generated by a content provider system device and/or by the electronic device using information provided by the content provider system device. If not, the flow may return to operation 310 where the electronic device may continue to operate. Otherwise, the flow may proceed to operation 330.

At operation 330, the electronic device transmits the content selection to the content provider system device. At operation 340, the electronic device obtains the content.

At operation 350, the electronic device determines whether or not to access the obtained content for presentation. The obtained content may be accessed for presentation as the electronic device receives the obtained content, from a recording or other stored copy, and so on. The electronic device may access the obtained content for presentation on an integrated and/or associated presentation device (such as a television, display, speaker, and so on) in response to user input. If not, the flow may return to operation 350 where the electronic device again determines whether or not to access the obtained content for presentation. Otherwise, the flow may proceed to operation 360.

At operation 360, the electronic device may track the duration of the access. The flow may then proceed to operation 370 where the electronic device may transmit data regarding the duration of the access to the content provider system device. The electronic device may periodically transmit the data, may transmit the data upon receipt of a request, may transmit the data upon reaching a charging time threshold or other triggering event, and so on.

In various examples, this example method 300 may be implemented as a group of interrelated software modules or components that perform various functions discussed herein. These software modules or components may be executed within a cloud network and/or by one or more computing devices, such as the content provider system device 101 of FIG. 1.

The flow may then return to operation 310 where the electronic device may continue to operate.

Although the example method 300 is illustrated and described as including particular operations performed in a particular order, it is understood that this is an example. In various implementations, various orders of the same, similar, and/or different operations may be performed without departing from the scope of the present disclosure.

For example, the method 300 is illustrated and described as obtaining the content before any of the content is accessed. However, it is understood that this is an example. In some implementations, the content may be accessed and tracked while the content is being received. Various implementations are possible and contemplated without departing from the scope of the present disclosure.

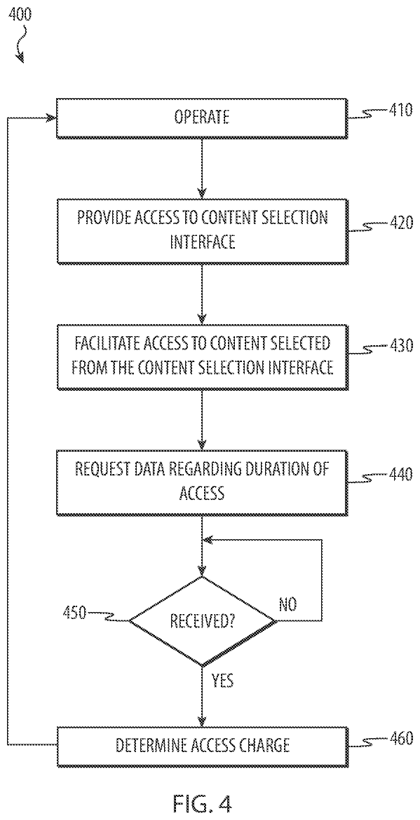

FIG. 4 depicts a flow chart illustrating a third example method 400 for tracking use of metered content from a content delivery system. This method 400 may be performed by the system 100 of FIG. 1.

At operation 410, an electronic device (such as the content provider system device 101 of FIG. 1) operates. The flow may proceed to operation 420 where the electronic device may provide access to a content selection interface. The flow may then proceed to operation 430 where the electronic device may facilitate access to content selected from the content selection interface.

Next, the flow may proceed to 440 where the electronic device may request data regarding the duration of the access to the content. The flow may proceed to operation 450 where the electronic device may determine whether or not the requested data is received. If not, the flow may return to operation 450 where the electronic device may again determine whether or not the requested data is received. Otherwise, the flow may proceed to 460.

At operation 460, the electronic device may determine an access charge for the access using at least the data. The electronic device may also use information about the content in determining the access charge, such as an amount to charge for the content for a particular period of time. The flow may then return to operation 410 where the electronic device may continue to operate.

In various examples, this example method 400 may be implemented as a group of interrelated software modules or components that perform various functions discussed herein. These software modules or components may be executed within a cloud network and/or by one or more computing devices, such as the content provider system device 101 of FIG. 1.

Although the example method 400 is illustrated and described as including particular operations performed in a particular order, it is understood that this is an example. In various implementations, various orders of the same, similar, and/or different operations may be performed without departing from the scope of the present disclosure.

For example, operation 440 is illustrated and described as the electronic device requesting the data. However, it is understood that this is an example. In some implementations, the electronic device may receive and/or otherwise obtain the data without requesting the data. Various configurations are possible and contemplated without departing from the scope of the present disclosure.

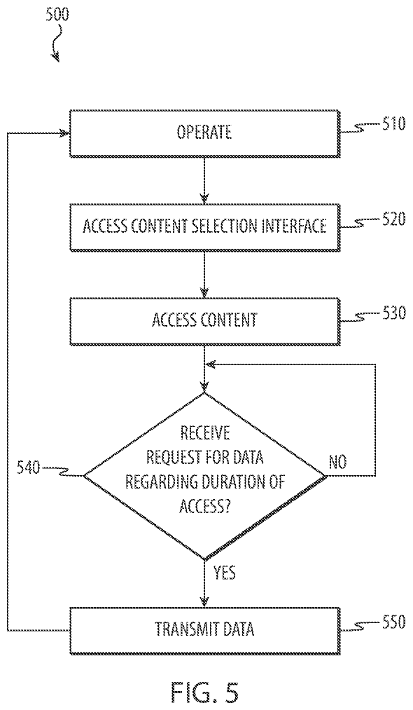

FIG. 5 depicts a flow chart illustrating a fourth example method 500 for tracking use of metered content from a content delivery system. This method 500 may be performed by the system 100 of FIG. 1.

At operation 510, an electronic device (such as the content provider system device 101 of FIG. 1) operates. The flow may proceed to operation 520 where the electronic device accesses a content selection interface. The flow may then proceed to operation 530 where the electronic device accesses content based on a selection from the content selection interface.

Next, the flow may proceed to operation 540 where the electronic device may determine whether a request for data regarding a duration of the access is received. If not, the flow may return to operation 540 where the electronic device may again determine whether a request for data regarding a duration of the access is received. Otherwise, the flow may proceed to operation 550.

At operation 550, the electronic device may transmit the requested data. The flow may then return to operation 510 where the electronic device may continue to operate.

In various examples, this example method 500 may be implemented as a group of interrelated software modules or components that perform various functions discussed herein. These software modules or components may be executed within a cloud network and/or by one or more computing devices, such as the content provider system device 101 of FIG. 1.

Although the example method 500 is illustrated and described as including particular operations performed in a particular order, it is understood that this is an example. In various implementations, various orders of the same, similar, and/or different operations may be performed without departing from the scope of the present disclosure.

For example, operation 540 is illustrated and described as the electronic device determining whether or not a request for the data is received. However, it is understood that this is an example. In some implementations, the electronic device may determine to transmit the data without receiving a request. For example, the electronic device may determine to transmit the data periodically, when access completes, upon the occurrence of a triggering event, and so on. Various configurations are possible and contemplated without departing from the scope of the present disclosure.

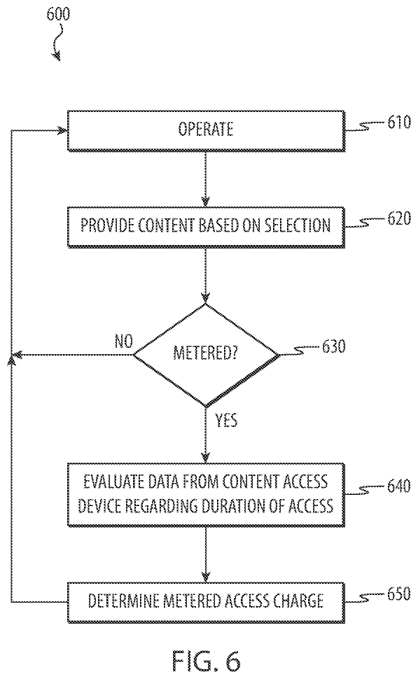

FIG. 6 depicts a flow chart illustrating a fifth example method 600 for tracking use of metered content from a content delivery system. This method 600 may be performed by the system 100 of FIG. 1.

At operation 610, an electronic device (such as the content provider system device 101 of FIG. 1) operates. The flow may proceed to operation 620 where the electronic device provides content to a content access device based on a selection. The flow may then proceed to operation 630 where the electronic device determines whether or not the content is metered. If not, the flow may return to operation 610 where the electronic device may continue to operate.

If it is determined that the content is metered, at operation 640, the electronic device may evaluate data from the content access device regarding a duration of the access. The flow may then proceed to operation 650 where the electronic device determines a metered access charge based at least on the duration of the access.

Next, the flow may return to operation 610 where the electronic device may continue to operate.

In various examples, this example method 600 may be implemented as a group of interrelated software modules or components that perform various functions discussed herein. These software modules or components may be executed within a cloud network and/or by one or more computing devices, such as the content provider system device 101 of FIG. 1.

Although the example method 600 is illustrated and described as including particular operations performed in a particular order, it is understood that this is an example. In various implementations, various orders of the same, similar, and/or different operations may be performed without departing from the scope of the present disclosure.

For example, the method 600 is illustrated and described as providing the content before determining whether or not the content is metered content. However, it is understood that this is an example. In other implementations, these operations may be reversed, be performed simultaneously, and/or be performed in other orders. Various configurations are possible and contemplated without departing from the scope of the present disclosure.

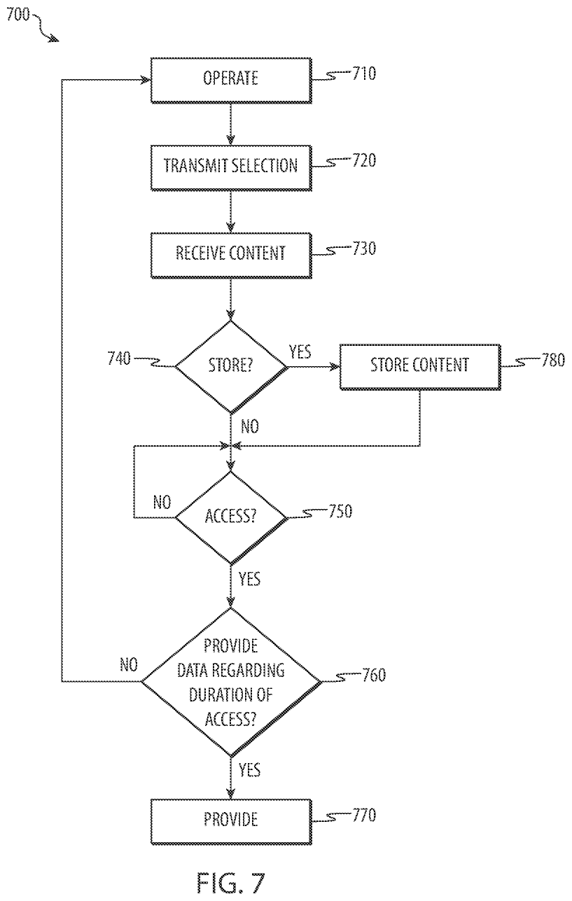

FIG. 7 depicts a flow chart illustrating a sixth example method 700 for tracking use of metered content from a content delivery system. This method 700 may be performed by the system 100 of FIG. 1.

At operation 710, an electronic device (such as the content access device 102 of FIG. 1) operates. The flow may proceed to operation 720 where the electronic device transmits a content selection. The flow may then proceed to operation 730 where the electronic device may receive the content.

At operation 740, the electronic device may determine whether or not to store the content. If so, the flow may proceed to operation 780 where the electronic device stores the content before the flow next proceeds to operation 750. Otherwise, the flow may proceed directly to operation 750.

At operation 750, the electronic device may determine whether or not to access the content for presentation. If not, the flow may return to operation 750 where the electronic device may again determine whether or not to access the content for presentation. Otherwise, the flow may proceed to operation 760.

At operation 760, the electronic device may determine whether or not to provide data regarding the duration of the access. For example, the electronic device may determine to transmit the data based on elapse of a time period (such as 15 minutes, an hour, a day, a week, a month, and so on), completion of the access, upon the occurrence of a triggering event, and so on. If so, the flow may proceed to operation 770 where the electronic device may provide the data regarding the duration of the access before the flow returns to operation 710 and the electronic device continues to operate. Otherwise, the flow may directly return to operation 710 and the electronic device continues to operate.

In various examples, this example method 700 may be implemented as a group of interrelated software modules or components that perform various functions discussed herein. These software modules or components may be executed within a cloud network and/or by one or more computing devices, such as the content provider system device 101 of FIG. 1.

Although the example method 700 is illustrated and described as including particular operations performed in a particular order, it is understood that this is an example. In various implementations, various orders of the same, similar, and/or different operations may be performed without departing from the scope of the present disclosure.

For example, operation 760 is illustrated and described as the electronic device determining whether or not to provide data regarding the duration of the access. However, it is understood that this is an example. In some implementations, the electronic device may provide data regarding the duration of the access without making any kind of determination to do so. Various configurations are possible and contemplated without departing from the scope of the present disclosure.

In various implementations, a content provider system may include a non-transitory storage medium that stores instructions, a communication unit, and a processor. The processor may execute the instructions to receive a content selection from a content access device using the communication unit, facilitate access by the content access device to content corresponding to the content selection, receive data regarding a duration of the access using the communication unit, and determine an access charge associated with the access at least using the data.

In some examples, the access charge may be associated with a charging time period for the content. In various such examples, the processor may determine the access charge using at least a number of times that the data indicates that the duration of the access exceeds the charging time period. In some such examples, the processor may determine that the access charge includes a time period charge when the duration of the access is within the charging time period. In a number of such examples, the processor may determine that the access charge includes a time period charge when the duration of the access is more than a minimum threshold and is less than the charging time period or equal to the charging time period.

In various examples, the data regarding the duration of the access may correspond to presentation of the content as the content is being received by the content access device. In a number of examples, the data regarding the duration of the access may correspond to presentation of the content from a stored copy of the content previously received by the content access device.

In some implementations, a content provider system may include a non-transitory storage medium that stores instructions, a communication unit, and a processor. The processor may execute the instructions to provide a content access device access to a content selection interface, facilitate content access by the content access device to content selected via the content selection interface, request data from the content access device regarding a duration of the content access, and determine an access charge using at least the data and the content.

In various examples, the processor may determine that the content is metered content before requesting the data. In some examples, the content may be a first content, the data may be first data, the duration may be a first duration, the content access may be a first content access, the processor may facilitate a second content access by the content access device to a second content selected via the content selection interface, the processor may determine that the second content is unmetered content, and the processor may omit requesting second data from the content access device regarding a second duration of the second content access. In a number of such examples, the second content may be flat charge content and the processor may add a flat charge for the second content to an aggregate access charge for an account associated with the content access device. In various such examples, the second content may be unassociated with a charge and the processor may omit adding the charge to an aggregate access charge for an account associated with the content access device.

In some examples, the processor may request the data after the content is provided to the content access device. In various examples, the processor may request the data periodically.

In a number of implementations, a content provider system may include a non-transitory storage medium that stores instructions, a communication unit, and a processor. The processor may execute the instructions to provide content to a content access device based on a selection from a content selection interface; upon determining that the content is metered content, evaluate data from the content access device regarding a duration of presentation of the content; and determine a metered access charge using at least the data.

In some examples, the processor may determine when an aggregate access charge for an account associated with the content access device reaches a notification threshold. In various examples, the processor may transmit a notification when an aggregate access charge for an account associated with the content access device reaches a configurable notification threshold. In a number of such examples, the processor may provide a recommendation regarding the content via the content selection interface.

In various examples, the processor may determine the metered access charge by including a minimum charge when an aggregate access charge for an account associated with the content access device is below a minimum threshold. In some examples, the processor may determine the metered access charge is zero when an aggregate access charge for an account associated with the content access device at least equals a maximum threshold.

As described above and illustrated in the accompanying figures, the present disclosure relates to a content provider system that provides content access devices access to metered content and receives data regarding the duration of content access device presentation of that metered content. For example, the metered content may be selected via a user interface to which the content provider system provides access to the content access device and the content provider system may receive the data regarding the duration periodically from the content access device, may request the data from the content access device, and so on. From the data, the content provider system is able to determine the provided metered content that was actually presented and for how long in order to charge for content that is actually used.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A content provider system, comprising:
a non-transitory storage medium that stores instructions;
a communication unit; and
a processor that executes the instructions to:
receive a content selection from a content access device using the communication unit;
facilitate access by the content access device to content corresponding to the content selection;
receive data regarding a duration of the access using the communication unit; and
determine an access charge associated with the access at least using the data.

2. The content provider system of claim 1, wherein the access charge is associated with a charging time period for the content.

3. The content provider system of claim 2, wherein the processor determines the access charge using at least a number of times that the data indicates that the duration of the access exceeds the charging time period.

4. The content provider system of claim 2, wherein the processor determines that the access charge includes a time period charge when the duration of the access is within the charging time period.

5. The content provider system of claim 2, wherein the processor determines that the access charge includes a time period charge when the duration of the access is more than a minimum threshold and is less than the charging time period or equal to the charging time period.

6. The content provider system of claim 1, wherein the data regarding the duration of the access corresponds to presentation of the content as the content is being received by the content access device.

7. The content provider system of claim 1, wherein the data regarding the duration of the access corresponds to presentation of the content from a stored copy of the content previously received by the content access device.

8. A content provider system, comprising:
a non-transitory storage medium that stores instructions;
a communication unit; and
a processor that executes the instructions to:
provide a content access device access to a content selection interface;
facilitate content access by the content access device to content selected via the content selection interface;
request data from the content access device regarding a duration of the content access; and
determine an access charge using at least the data and the content.

9. The content provider system of claim 8, wherein the processor determines that the content is metered content before requesting the data.

10. The content provider system of claim 8, wherein:
the content is a first content;
the data is first data;
the duration is a first duration;
the content access is a first content access;
the processor facilitates a second content access by the content access device to a second content selected via the content selection interface;
the processor determines that the second content is unmetered content; and
the processor omits requesting second data from the content access device regarding a second duration of the second content access.

11. The content provider system of claim 10, wherein:
the second content is flat charge content; and
the processor adds a flat charge for the second content to an aggregate access charge for an account associated with the content access device.

12. The content provider system of claim 10, wherein:
the second content is unassociated with a charge; and
the processor omits adding the charge to an aggregate access charge for an account associated with the content access device.

13. The content provider system of claim 8, wherein the processor requests the data after the content is provided to the content access device.

14. The content provider system of claim 8, wherein the processor requests the data periodically.

15. A content provider system, comprising:
a non-transitory storage medium that stores instructions;
a communication unit; and
a processor that executes the instructions to:
provide content to a content access device based on a selection from a content selection interface;
upon determining that the content is metered content, evaluate data from the content access device regarding a duration of presentation of the content; and
determine a metered access charge using at least the data.

16. The content provider system of claim 15, wherein the processor determines when an aggregate access charge for an account associated with the content access device reaches a notification threshold.

17. The content provider system of claim 15, wherein the processor transmits a notification when an aggregate access charge for an account associated with the content access device reaches a configurable notification threshold.

18. The content provider system of claim 15, wherein the processor provides a recommendation regarding the content via the content selection interface.

19. The content provider system of claim 15, wherein the processor determines the metered access charge by including a minimum charge when an aggregate access charge for an account associated with the content access device is below a minimum threshold.

20. The content provider system of claim 15, wherein the processor determines the metered access charge is zero when an aggregate access charge for an account associated with the content access device at least equals a maximum threshold.
